(19) United States
(12) Patent Application Publication
(10) Pub. No.: US 2020/0266448 A1
(43) Pub. Date: Aug. 20, 2020

(54) ELECTRODE, ALL SOLID STATE BATTERY AND METHOD FOR PRODUCING ELECTRODE

(71) Applicant: TOYOTA JIDOSHA KABUSHIKI KAISHA, Toyota-shi (JP)

(72) Inventors: Naoki OSADA, Shizuoka-ken (JP); Ryuto SAKAMOTO, Okazaki-shi (JP); Naohiro MASHIMO, Susono-shi (JP); Hideki HAGIWARA, Nagoya-shi (JP)

(21) Appl. No.: 16/789,387

(22) Filed: Feb. 12, 2020

(30) Foreign Application Priority Data
Feb. 14, 2019 (JP) 2019-024375
Jan. 31, 2020 (JP) 2020-015011

(51) Int. Cl. H01M 4/66; H01M 10/0525; H01M 10/0562; H01M 4/137

(52) U.S. Cl. CPC H01M 4/661; H01M 4/667; H01M 4/137; H01M 10/0562; H01M 10/0525

(57) ABSTRACT

A main object of the present disclosure is to provide an electrode wherein contact resistance between a modifying layer and an active material layer, under low confining pressure condition, is low. In the present disclosure, the above object is achieved by providing an electrode used for an all solid state battery, and the electrode comprises a current collector, a modifying layer including a polymer and a conductive auxiliary material, and an active material layer, in this order, and when a volume resistivity value of the modifying layer is regarded as R_{A}, and a volume resistivity value of the active material layer is regarded as R_{B}, R_{B}/R_{A} is 8×10³ or less, and the R_{B} is 40 Ω·cm or less.

### RELATED APPLICATIONS

This application claims priority to Japanese Patent Application No. 2019-024375, filed on Feb. 14, 2019, and Japanese Patent Application No. 2020-015011, filed Jan. 31, 2020, including the specifications, drawings and abstracts, the entire disclosures of which are incorporated herein by reference.

### TECHNICAL FIELD

The present disclosure relates to an electrode wherein contact resistance between a modifying layer and an active material layer, under low confining pressure condition, is low.

### BACKGROUND ART

An all solid state battery is a battery including a solid electrolyte layer between a cathode and an anode, and an advantage thereof is that the simplification of a safety device may be more easily achieved compared to a liquid based battery including a liquid electrolyte containing a flammable organic solvent.

Patent Literature 1 discloses an all solid state battery comprising a PTC layer between a current collector and an active material layer, and including a confining member that applies a confining pressure in a stacked direction. Also, although it is not an all solid state battery, Patent Literature 2 discloses a non-aqueous secondary battery comprising an electron conductive layer between an electrode mixture and a current collector.

### CITATION LIST

### Patent Literatures

Patent Literature 1: Japanese Patent Application Laid-Open (JP-A) No. 2018-014286

Patent Literature 2: JP-A No. 2012-104422

### SUMMARY OF DISCLOSURE

### Technical Problem

The PTC layer is placed between an active material layer and a current collector, and functions as a modifying layer. By providing such a modifying layer, the resistance in an all solid state battery may be increased so as to prevent further increase of the battery temperature, when the temperature of the all solid state battery is increased for some reason. Meanwhile, although the modifying layer usually includes a conductive auxiliary material, the contact resistance with respect to the active material layer tends to be high. Particularly, when the confining pressure of the all solid state battery is low, the contact resistance between the modifying layer and the active material layer is desirably low.

The present disclosure has been made in view of the above circumstances, and a main object thereof is to provide an electrode wherein contact resistance between a modifying layer and an active material layer, under low confining pressure condition, is low.

### Solution to Problem

In order to achieve the object, provided is an electrode used for an all solid state battery, and the electrode comprises a current collector, a modifying layer including a polymer and a conductive auxiliary material, and an active material layer, in this order, and when a volume resistivity value of the modifying layer is regarded as R_{A}, and a volume resistivity value of the active material layer is regarded as R_{B}, R_{B}/R_{A} is 8×10³ or less, and the R_{B} is 40 Ω·cm or less.

According to the present disclosure, since the volume resistivity of the modifying layer and the active material layer satisfy the specific relation, the contact resistance between the modifying layer and the active material layer, under low confining pressure condition, may be decreased in the electrode.

In the disclosure, the R_{A} may be 0.01 Ω·cm or less.

In the disclosure, the R_{A} may be 0.005 Ω·cm or more.

In the disclosure, the R_{B} may be 22 Ω·cm or more.

In the disclosure, the R_{B}/R_{A} may be 3.8×10³ or more.

In the disclosure, a spring constant per unit area of the modifying layer may be 1 MPa/μm or more and 7 MPa/μm or less.

The present disclosure also provides an all solid state battery comprising: a cathode, a solid electrolyte layer, and an anode, in this order, and at least one of the cathode and the anode is the above described electrode.

According to the present disclosure, since at least one of the cathode and the anode is the above described electrode, the contact resistance between the modifying layer and the active material layer, under low confining pressure condition, may be decreased in the all solid state battery.

In the disclosure, the all solid state battery may further comprise a confining member that applies a confining pressure in the thickness direction of the cathode, the solid electrolyte layer and the anode, and the confining pressure may be 0.05 MPa or more and 3 MPa or less.

In the disclosure, a spring constant per unit area of the modifying layer may be 1 MPa/μm or more and 7 MPa/μm or less, and the confining pressure may be 0.2 MPa or more and 3 MPa or less.

In the disclosure, the cathode may be the electrode.

The present disclosure also provides a method for producing the above described electrode, the method characterized by comprising steps of: a first preparing step of preparing a first member including the current collector and the modifying layer formed on one side of the current collector, a second preparing step of preparing a second member including a base material and the active material layer formed on one side of the base material, and a joining step of joining the modifying layer in the first member and the active material layer in the second member, facing to each other.

According to the present disclosure, by making the volume resistivity of the modifying layer and the active material layer in the specific relation, an electrode wherein the contact resistance between a modifying layer and an active material layer, under low confining pressure condition, is low may be obtained. Further, by forming the first member including the modifying layer and the second member including the active material layer as separate bodies, and then, joining the two, an occurrence of unevenness in the thickness of the active material layer may be inhibited.

### Advantageous Effects of Disclosure

The electrode in the present disclosure exhibits an effect that the contact resistance between the modifying layer and the active material layer, under low confining pressure condition, is low.

### BRIEF DESCRIPTION OF DRAWINGS

FIG. 1 is a schematic cross-sectional view illustrating an example of the electrode in the present

### DISCLOSURE

FIG. 2 is a schematic cross-sectional view illustrating an example of the all solid state battery in the present disclosure.

FIG. 3 is a flow chart illustrating an example of the method for producing the electrode in the present disclosure.

FIGS. 4A-4F are schematic cross-sectional views illustrating an example of the electrode in the present disclosure.

### DESCRIPTION OF EMBODIMENTS

The electrode, the all solid state battery and the method for producing the electrode in the present disclosure will be hereinafter described in detail.

A. Electrode

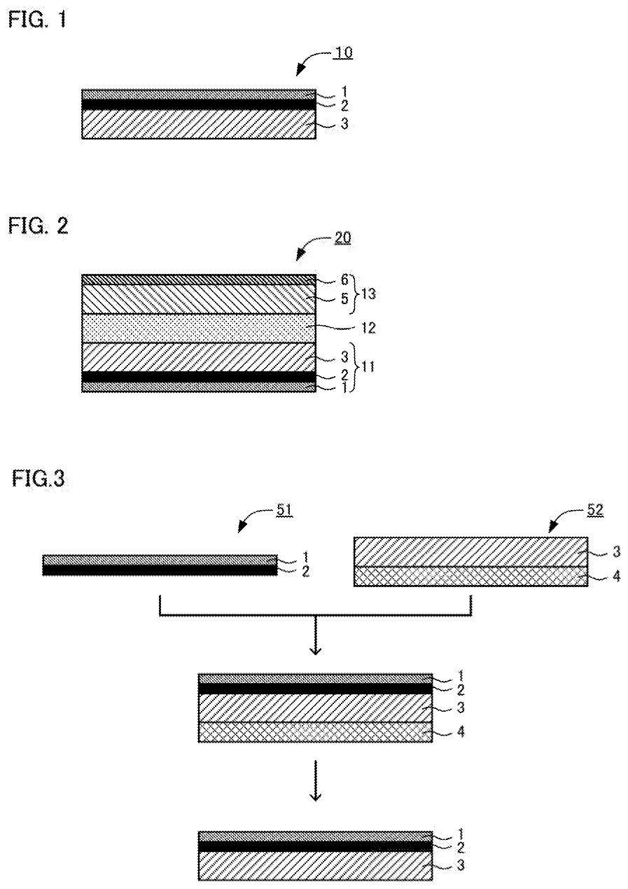

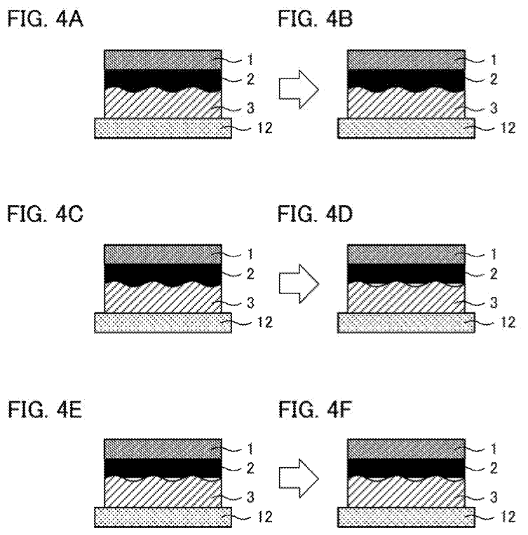

FIG. 1 is a schematic cross-sectional view illustrating an example of the electrode in the present disclosure. Electrode 10 illustrated in FIG. 1 comprises current collector 1, modifying layer 2 and active material layer 3, in this order. Also, the volume resistivity (R_{A}) of modifying layer 2 and the volume resistivity (R_{B}) of active material layer 3 satisfy the specific relation.

According to the present disclosure, since the volume resistivity of the modifying layer and the active material layer satisfy the specific relation, the contact resistance between a modifying layer and an active material layer, under low confining pressure condition, may be decreased in the electrode. Incidentally, the confining pressure applied to the all solid state battery will be described in “B. All solid state battery”. Also, as described above, by providing the modifying layer, the resistance in the all solid state battery may be increased so as to prevent further increase of the battery temperature, when the temperature of the all solid state battery is increased for some reason. This is because mainly the electron conductive path is cut off due to the expansion of the polymer included in the modifying layer by heat. Meanwhile, although the modifying layer usually includes a conductive auxiliary material, the contact resistance with respect to the active material layer tends to be high.

In contrast, the contact resistance between the modifying layer and the active material layer, under low confining pressure condition, may be notably decreased in the present disclosure by focusing on the volume resistivity (R_{A}) of the modifying layer and the volume resistivity (R_{B}) of the active material layer, and making the ratio of the two in the specific range. Although the mechanism for the contact resistance being decreased is not clear, it is presumed that, since the conductive auxiliary material is exposed on the surface of the active material layer in contact with the modifying layer, the frequency of the two layers being in contact with each other via this exposed portion, that is, the frequency of being in contact electrically is made higher.

The electrode in the present disclosure will be hereinafter described in each constitution.

1. Modifying Layer

The modifying layer is a layer formed between the later described active material layer and the later described current collector, and usually a layer including at least a polymer and a conductive auxiliary material. The modifying layer in the present disclosure is also referred to as a PTC layer. PTC is “Positive Temperature Coefficient”, and the PTC layer indicates a layer having PTC property, a characteristic of varying electric resistance thereof with a positive coefficient in connection with a temperature increase.

Also, when the volume resistivity value of the modifying layer is regarded as R_{A}, and the volume resistivity value of the active material layer is regarded as R_{B}, the proportion of R_{B} to R_{A} (R_{B}/R_{A}) is usually 8×10³ or less, may be 7.2×10³ or less, and may be 6.8×10³ or less. Meanwhile, R_{B}/R_{A} is, for example, 2×10³ or more, and may be 3.8×10³ or more.

R_{A} is, for example, 0.1 Ω·cm or less, may be 0.05 Ω·cm or less, and may be 0.01 Ω·cm or less. Meanwhile, R_{A} is, for example, 0.001 Ω·cm or more, and may be 0.005 Ω·cm or more. R_{A} may be adjusted by varying a condition such as kind and compound ratio of each component described later, included in the modifying layer.

The conductive auxiliary material is not particularly limited; examples thereof may include carbon material. Examples of the carbon material may include carbon blacks such as furnace black, acetylene black, Ketjen black, and thermal black; fibrous carbons such as carbon nanotube, and carbon nanofiber (VGCF); activated carbon; carbon; graphite; graphene; and fullerene. The shape of the conductive auxiliary material is not particularly limited; examples may include a granular shape and fibrous shape. The average particle size (D₅₀) of the conductive auxiliary material is, for example, 1 nm or more and 1 μm or less, and may be 10 nm or more and 500 nm or less. Here, the average particle size of the conductive auxiliary material may be determined based on, for example, an image analysis with SEM (scanning electron microscope). The number of the sample is preferably large; for example, 100 or more.

The proportion of the conductive auxiliary material in the modifying layer is, for example, 5 weight % or more, may be 10 weight % or more, and may be 15 weight % or more. Meanwhile, the proportion of the conductive auxiliary material in the modifying layer is, for example, 30 weight % or less, may be 25 weight % or less, and may be 20 weight % or less.

The polymer is not particularly limited if a volume expansion is possible upon a temperature increase, and examples may include thermoplastic resin. Examples of the thermoplastic resin may include polyvinylidene fluoride (PVDF), polypropylene, polyethylene, polyvinyl chloride, polystyrene, acrylonitrile butadiene styrene (ABS) resin, methacryl resin, polyamide, polyester, polycarbonate, and polyacetal.

The melting point of the polymer may be a temperature higher than the normal operating temperature of the battery, and is, for example, 80° C. or more and 300° C. or less, and may be 100° C. or more and 250° C. or less. The melting point may be measured by, for example, a differential thermal analysis (DTA).

The proportion of the polymer in the modifying layer is, for example, 60 weight % or more, may be 70 weight % or more, and may be 80 weight % or more. Meanwhile, the proportion of the polymer in the modifying layer is, for example, 95 weight % or less, may be 90 weight % or less, and may be 85 weight % or less. Also, the proportion of the polymer to the total of the polymer and the conductive auxiliary material in the modifying layer is, for example, 60 weight % or more, may be 70 weight % or more, and may be 80 weight % or more. Meanwhile, the proportion of the polymer to the total of the polymer and the conductive auxiliary material in the modifying layer is, for example, 95 weight % or less, may be 90 weight % or less, and may be 85 weight % or less.

The modifying layer in the present disclosure may include just the polymer and the conductive auxiliary material, and may further include additional material. Examples of the additional material may include a filler. By including the filler, the deformation and the flowing of the molten polymer upon temperature increase may be inhibited, and may exert higher PTC effect. The kind of the filler is not particularly limited, and examples may include a metal oxide and a metal nitride. Examples of the metal oxide may include alumina, zirconia and silica. Examples of the metal nitride may include silicon nitride. Also, ceramic material may be used as the filler. The shape of the filler is not particularly limited, and examples may include a granular shape. The average particle size (D₅₀) of the filler is, for example, 50 nm or more and 5 μm or less, and may be 100 nm or more and 2 μm or less. The proportion of the filler in the modifying layer is, for example, 5 weight % or more and 95 weight % or less.

The spring constant per unit area of the modifying layer is, for example, 0.5 MPa/μm or more, and may be 1 MPa/μm or more. Meanwhile, the spring constant per unit area of the modifying layer is, for example, 10 MPa/μm or less, and may be 7 MPa/μm or less. Particularly, when the spring constant per unit area of the modifying layer is 1 MPa/μm or more and 7 MPa/μm or less, the contact resistance before the durability test (initial) may be lowered greatly, and further, the contact resistance after the durability test may be maintained low.

The spring constant per unit area of the modifying layer may be determined by dividing the spring constant of the modifying layer by the area of the modifying layer. Determining the spring constant of the modifying layer as the numerical value per unit area makes it easy to evaluate the relationship to the confining pressure (usually, the confining pressure per unit area).

When the spring constant per unit area of the modifying layer is in the specific range, initially, as shown in FIG. 4A for example, modifying layer 2 is placed so as to conform the surface profile of active material layer 3, and the contact resistance will be low. As shown in FIG. 4B, the above described condition will be maintained after the durability test, and the contact resistance will be maintained low.

In contrast to the above, when the spring constant per unit area of the modifying layer is too low, initially, as shown in FIG. 4C for example, modifying layer 2 is placed so as to conform the surface profile of active material layer 3, and the contact resistance will be low. Meanwhile, when a durability test is carried out, the creep amount (plastic deformation amount) of modifying layer 2 increases over time, and as shown in FIG. 4D, a gap tends to occur between modifying layer 2 and active material layer 3 so that the contact resistance after the durability test tends to be high.

Also, when the spring constant per unit area of the modifying layer is too high, initially, as shown in FIG. 4E for example, modifying layer 2 is not placed so as to conform the surface profile of active material layer 3, and the contact resistance tends to be high. As shown in FIG. 4F, the above described condition will be maintained also after the durability test, and the contact resistance tends to be high.

The thickness of the modifying layer is, for example, 0.5 μm or more, and may be 1 μm or more. Meanwhile, the thickness of the modifying layer is, for example, 20 μm or less, and may be 10 μm or less. Incidentally, the modifying layer is preferably in direct contact with the current collector. Similarly, the modifying layer is preferably in direct contact with the active material layer.

2. Active Material Layer

The active material layer is a layer including at least an active material. Also, the active material layer may further include at least one of a solid electrolyte, a conductive auxiliary material and a binder, in addition to the active material. Also, as described above, when the volume resistivity value of the active material layer is regarded as R_{B}, it satisfies the specific relation to the volume resistivity value of the modifying layer R_{A}.

R_{B} is usually 40 Ω·cm or less, may be 38 Ω·cm or less, and may be 36 Ω·cm or less. Meanwhile, R_{B} is, for example, 5 Ω·cm or more, may be 10 Ω·cm or more, and may be 22 Ω·cm or more. R_{B} may be adjusted by varying a condition such as kind and compound ratio of each component described later included in the active material layer.

When the electrode in the present disclosure is used as a cathode, examples of the cathode active material may include rock salt bed type active materials such as lithium cobaltite (LiCoO₂), lithium nickelate (LiNiO₂) and LiNi_{1/3}Co_{1/3}Mn_{1/3}O₂; spinel type active materials such as lithium manganate (LiMn₂O₄), and Li(Ni_{0.5}Mn_{1.5})O₄; and olivine type active materials such as LiFePO₄, LiMnPO₄, LiCoPO₄, and LiNiPO₄; and lithium titanate (Li₄Ti₅O₁₂). Examples of the shape of the cathode active material may include a granular shape and a thin-film shape. When the cathode active material has the granular shape, the cathode active material may be a primary particle and may be a secondary particle. Also, the average particle size (D₅₀) of the cathode active material is, for example, 1 nm or more and 100 μm or less, and may be 10 nm or more and 30 μm or less.

When the electrode in the present disclosure is used as an anode, examples of the anode active material may include a metal active material, a carbon active material and an oxide active material. Examples of the metal active material may include Li, In, Al, Si, and Sn. Meanwhile, examples of the carbon active material may include mesocarbon microbead (MCMB), highly oriented graphite (HOPG), hard carbon, and soft carbon. Examples of the oxide active material may include Li₄Ti₅O₁₂. Examples of the shape of the anode active material may include a granular shape and a thin-film shape. When the anode active material has the granular shape, the anode active material may be a primary particle and may be a secondary particle. Also, the average particle size (D₅₀) of the anode active material is, for example, 1 nm or more and 100 μm or less, and may be 10 nm or more and 30 μm or less.

Examples of the solid electrolyte may include inorganic solid electrolytes such as a sulfide solid electrolyte, an oxide solid electrolyte, nitride solid electrolyte, and halide solid electrolyte.

Examples of the sulfide solid electrolyte may include solid electrolyte including a Li element, an X element (X is at least one kind of P, Si, Ge, Sn, B, Al, Ga, and In) and a S element. Also, the sulfide solid electrolyte may further include at least either one of an O element and a halogen element. Examples of the sulfide solid electrolyte may include Li₂S—P₂S₅, Li₂S—P₂S₅—Li₃PO₄, LiI—P₂S₅—Li₃PO₄, Li₂S—P₂S₅—LiI, Li₂S—P₂S₅—LiI—LiBr, Li₂S—P₂S₅—Li₂O, Li₂S—P₂S₅—Li₂O—LiI, Li₂S—P₂O₅, LiI—Li₂S—P₂O₅, Li₂S—SiS₂, Li₂S—SiS₂—LiI, Li₂S—SiS₂—LiI—LiBr, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m, n are positive numbers; Z is any one of Ge, Zn, and Ga), Li₂S—GeS₂, Li₂S—SiS₂—Li₃PO₄, Li₂S—SiS₂-Li_{×}MO_{y} (provided that x, y are positive numbers; M is any one of P, Si, Ge, B, Al, Ga, and In).

Also, examples of the oxide solid electrolyte may include solid electrolyte including a Li element, a Y element (Y is at least one kind of Nb, B, Al, Si, P, Ti, Zr, Mo, W and S) and an O element. Also, examples of the nitride solid electrolyte may include Li₃N, and examples of the halide solid electrolyte may include LiCl, LiI and LiBr.

The conductive auxiliary material is in the same contents as those described in “1. Modifying layer” above. The proportion of the conductive auxiliary material to the active material in the active material layer is, for example, 0.5 weight % or more, may be 1 weight % or more, and may be 1.5 weight % or more. Meanwhile, the proportion of the conductive auxiliary material to the active material in the active material layer is, for example, 8 weight % or less, and may be 6 weight % or less. Also, examples of the binder may include fluorine based binders such as polyvinylidene fluoride (PVDF) and polytetrafluoroethylene (PTFE); and rubber based binders.

Also, the active material layer may include a first mixture layer and a second mixture layer. In this case, the electrode in the present disclosure may include the current collector, the modifying layer, the first mixture layer, and the second mixture layer in this order, and the first mixture layer may include more conductive auxiliary material than the second mixture layer. Such active material layer is able to expose more conductive auxiliary material at the surface contacting the modifying layer. The kind of the component included in the first mixture layer and the second mixture layer are preferably the same.

Also, the thickness of the active material layer is, for example, 0.1 μm or more and 1000 μm or less. The active material layer in the present disclosure may be formed according to, for example, the method for producing the electrode described later.

3. Current Collector

The current collector in the present disclosure has a function of collecting current in the above described active material layer. A known metal usable as a cathode current collector or an anode current collector of an all solid state battery may be used as the material for the current collector. Examples of the metal may include a metal including one or more metal element such as Cu, Ni, Al, V, Au, Pt, Mg, Fe, Ti, Co, Cr, Zn, Ge and In. The shape of the current collector is not particularly limited; examples may include a foil shape, a mesh shape, and a porous shape.

4. Electrode

In the electrode in present disclosure, the contact resistance (per unit area) between the modifying layer and the active material layer under confining pressure of 0.2 MPa is, for example, 10Ω or less, and may be 4.2Ω or less. Meanwhile, the contact resistance under confining pressure of 0.2 MPa is, for example, 1Ω or more, and may be 1.9Ω or more. Also, the contact resistance under confining pressure of 0.5 MPa is, for example, 5Ω or less, and may be 2.7Ω or less. Meanwhile the contact pressure under confining pressure of 0.5 MPa is, for example, 1Ω or more, and may be 1.6Ω or more. Also, the contact resistance under confining pressure of 1 MPa is, for example, 5Ω or less, and may be 2.6Ω or less. Meanwhile the contact pressure under confining pressure of 1 MPa is, for example, 0.3Ω or more, and may be 0.5Ω or more.

The electrode in the present disclosure is used for an all solid state battery. The all solid state battery will be described in detail in “B. All solid state battery”. Also, a method for producing the electrode in the present disclosure will be described in detail in “C Method for producing electrode”.

B. All Solid State Battery

The all solid state battery in the present disclosure comprises a cathode, a solid electrolyte layer, and an anode, in this order, and at least one of the cathode and the anode is the above described electrode. FIG. 2 is a schematic cross-sectional view illustrating an example of the all solid state battery in the present disclosure. All solid state battery 20 illustrated in FIG. 2 comprises cathode 11, solid electrolyte layer 12 and anode 13, in this order. Also, in FIG. 2, cathode 11 corresponds to the above described electrode. Incidentally, anode 13 in FIG. 2 includes anode active material layer 5 and anode current collector 6.

According to the present disclosure, since at least one of the cathode and the anode is the above described electrode, the contact resistance between a modifying layer and an active material layer, under low confining pressure condition, may be decreased in the all solid state battery. Incidentally, the electrode is in the same contents as those described in “A. Electrode” above; thus, the descriptions herein are omitted.

The solid electrolyte layer is a layer formed between the cathode active material layer in the cathode and the anode active material layer in the anode. The solid electrolyte used in the solid electrolyte layer is similar to those described in “2. Active material layer” above.

Also, the solid electrolyte layer may include just the solid electrolyte, and may further include other material. Examples of the other material may include a binder. The binder is similar to those described in “2. Active material layer” above. The thickness of the solid electrolyte layer is preferably, for example, 0.1 μm or more and 1000 μm or less.

Also, the all solid state battery in the present disclosure preferably includes a confining member that applies a confining pressure in the thickness direction of the cathode, the solid electrolyte layer and the anode. The confining pressure is, for example, 0.05 MPa or more, may be 0.1 MPa or more, may be 0.2 MPa or more, and may be 0.5 MPa or more. Meanwhile, the confining pressure is, for example, 10 MPa or less, may be 5 MPa or less, may be 3 MPa or less, and may be 1 MPa or less. Also, the all solid state battery may include an outer packing that houses the above described cathode, solid electrolyte layer and anode.

The all solid state battery in the present disclosure is preferably an all solid state lithium battery. Also, the all solid state battery may be a primary battery, and may be a secondary battery. Among the above, the secondary battery is preferable, so as to be repeatedly charged and discharged, and is useful as, for example, a car-mounted battery. Also, examples of the shape of the all solid state battery may include a coin shape, a laminate shape, a cylindrical shape, and a square shape.

C. Method for Producing Electrode

FIG. 3 is a flow chart illustrating an example of the method for producing the electrode in the present disclosure. As shown in FIG. 3, the method for producing the electrode in the present disclosure comprises steps of: a first preparing step of preparing first member 51 including current collector 1 and modifying layer 2 formed on one side of current collector 1, a second preparing step of preparing second member 52 including base material 4 and active material layer 3 formed on one side of base material 4, and a joining step of joining modifying layer 2 in first member 51 and active material layer 3 in second member 52, facing to each other. Thereby, an electrode comprising current collector 1, modifying layer 2, active material layer 3 and base material 4 may be obtained. Further, by peeling base material 4 off, an electrode comprising current collector 1, modifying layer 2 and active material layer 3 may be obtained.

According to the present disclosure, by making the volume resistivity of the modifying layer and the active material layer in the specific relation, an electrode wherein the contact resistance between a modifying layer and an active material layer, under low confining pressure condition, is low may be obtained. Further, by forming the first member including the modifying layer and the second member including the active material layer as separate bodies, and then, joining the two, an occurrence of unevenness in the thickness of the active material layer may be inhibited. When a current collector including a modifying layer is directly coated with a slurry for forming a active material layer, the thickness of the active material layer tends to be uneven, if the wettability of the slurry to the modifying layer is poor. In contrast to this, in the present disclosure, since the first member including the modifying layer and the second member including the active material layer are formed as separate bodies, and then, these are joined, an occurrence of unevenness in the thickness of the active material layer may be inhibited. Meanwhile, when the first member and the second member are formed as separate bodies, and these are joined thereafter, there is a possibility that the contact between the modifying layer and the active material layer is not sufficient resulting in a high contact resistance. Even in such a case, an electrode with low contact resistance may be obtained by making the volume resistivity of the modifying layer and the active material layer in the specific relation.

1. First Preparing Step

The first preparing step in the present disclosure is a step of preparing the first member including the current collector and the modifying layer formed on one side of the current collector.

Examples of a method for forming the modifying layer on one side of the current collector may include a method wherein a current collector is coated with a slurry for forming a modifying layer and dried. The slurry includes at least a polymer, a conductive auxiliary material and a solvent (dispersant). This slurry may further include a filler. Examples of the solvent may include butyl butyrate and heptane. Also, any known method may be employed for the method for coating the slurry.

2. Second Preparing Step

The second preparing step in the present disclosure is a step of preparing a second member including a base material and the active material layer formed on one side of the base material. The base material is not particularly limited, and examples may include the materials same as the above described current collector.

Examples of a method for forming the active material layer on one side of the base material may include a method wherein a base material is coated with a slurry for forming an active material layer and dried. The slurry includes at least an active material and a solvent (dispersant). This slurry may further include at least one of a solid electrolyte, conductive auxiliary material and a binder. Examples of the solvent may include butyl butyrate and heptane. Also, any known method may be employed for the method for coating the slurry. Incidentally, an active material layer including the above described first mixture layer and second mixture layer may be formed by preparing two kind of slurries with different conductive auxiliary material content, coating the base material with the slurry with lower conductive auxiliary material, and applying the slurry with more conductive auxiliary material thereon.

3. Joining Step

The joining step in the present disclosure is a step of joining the modifying layer in the first member and the active material layer in the second member, facing to each other. Examples of a method for joining the first member and the second member may include a pressing method.

4. All Solid State Battery

The all solid state battery obtained in each above described step is in the same contents as those described in “B. All solid state battery” above; thus, the descriptions herein are omitted.

Incidentally, the present disclosure is not limited to the embodiments. The embodiments are exemplification, and other variations are intended to be included in the technical scope of the present disclosure if they have substantially the same constitution as the technical idea described in the claim of the present disclosure and offer similar operation and effect thereto.

### EXAMPLES

### Example 1

<Production of First Member>

VGCF as a conductive auxiliary material and PVDF as a polymer were weighed so as the volume ratio was conductive auxiliary material:polymer=20:80, dispersed into N-methylpyrrolidone (NMP) to prepare a precursor composition of a modifying layer. A current collector (Al foil) was coated with the obtained precursor composition to have a thickness of 2 μm, dried at 100° C. for 1 hour to obtain a first member including a current collector and a modifying layer.

<Production of Second Member>

A cathode active material (LiNi_{1/3}Co_{1/3}Mn_{1/3}O₂), a conductive auxiliary material (VGCF, from Showa Denko K. K.), a sulfide solid electrolyte (Li₂S—P₂S₅ based glass ceramic) and a binder solution (a butyl butyrate solution containing a 5 weight % of PVDF) were added to a container made of polypropylene (PP). On this occasion, the amount of the conductive auxiliary material to the cathode active material was 2 weight %. An ultrasonic treatment was carried out to the container by an ultrasonic dispersion apparatus (UH-50, from SMT Corp.) for 30 seconds, then, a shaking treatment was carried out by using a shaker (TTM-1, from Sibata Scientific Technology LTD.) for 30 minutes, and slurry was obtained. The obtained slurry was pasted on a base material (Al foil) by a blade method using an applicator, dried naturally, dried for 30 minutes on a hot plate adjusted to be 100° C. Thereby, a second member including a base material and a cathode active material layer was obtained.

<Production of Cathode>

A cathode was obtained by pressing the modifying layer in the first member and the cathode active material layer in the second member, facing to each other, to join them, and peeling off the base material.

### Example 2

A cathode was produced in the same manner as in Example 1 except that the amount of the conductive auxiliary material to the cathode active material in the cathode active material layer was changed to 2.5 weight %.

### Example 3

A cathode was produced in the same manner as in Example 1 except that the amount of the conductive auxiliary material to the cathode active material in the cathode active material layer was changed to 3 weight %.

### Example 4

A cathode was produced in the same manner as in Example 1 except that the amount of the conductive auxiliary material to the cathode active material in the cathode active material layer was changed to 4 weight %.

### Example 5

A cathode was produced in the same manner as in Example 1 except that the amount of the conductive auxiliary material to the cathode active material in the cathode active material layer was changed to 6 weight %.

### Example 6

A cathode was produced in the same manner as in Example 1 except that the materials were weighed so as the volume ratio was conductive auxiliary material:polymer=15:85 in the modifying layer, and the amount of the conductive auxiliary material to the cathode active material in the cathode active material layer was changed to 3 weight %.

### Comparative Example 1

A cathode was produced in the same manner as in Example 1 except that the amount of the conductive auxiliary material to the cathode active material in the cathode active material layer was changed to 1.25 weight %.

### Comparative Example 2

A cathode was produced in the same manner as in Example 1 except that the amount of the conductive auxiliary material to the cathode active material in the cathode active material layer was changed to 1.5 weight %.

### Comparative Example 3

A cathode was produced in the same manner as in Example 1 except that the materials were weighed so as the volume ratio was conductive auxiliary material:polymer=15:85 in the modifying layer, and the amount of the conductive auxiliary material to the cathode active material in the cathode active material layer was changed to 1.5 weight %.

[Evaluation]

<Measurement of Volume Resistivity>

The volume resistivity (R_{A}) was calculated from the voltage transition upon applying a direct current to the first members, produced in Examples 1 to 6 and Comparative Examples 1 to 3, sandwiched between SUS electrodes. Incidentally, although the volume resistivity of the first member (cathode current collector and modifying layer) was measured, it may be said that the volume resistivity of the modifying layer was actually measured since the resistance of the cathode current collector was extremely low. Also, the volume resistivity (R_{B}) was calculated from the voltage transition upon applying a direct current to the cathode active material layer, obtained by peeling the base material off from the second members produced in Examples 1 to 6 and Comparative Examples 1 to 3, sandwiched between SUS electrodes. In the specific method for measuring R_{A} and R_{B}, an arbitrarily direct current about 0.1 mA to 1 mA was applied to three points or more with an electrochemical measuring apparatus, a voltage variation ΔV occurred at the time was measured, and resistance α per unit area was calculated based on Ohm's law. Further, the volume resistivity (R_{A} and R_{B}) was calculated by dividing this resistance α by the thickness of each member (for the second member, the thickness of the active material layer). The results are shown in Table 1.

<Measurement of Contact Resistance>

The resistance was determined from the voltage transition upon applying a direct current to the cathodes, produced in Examples 1 to 6 and Comparative Examples 1 to 3, sandwiched between SUS electrodes and confining pressure applied. The contact resistance was calculated from the difference between the obtained resistance and the total of the resistance of the first member and the resistance of the second member. The results are shown in Table 1.

<Measurement of Battery Cell Resistance>

A battery cell was produced with the cathodes produced in Examples 1 to 6 and Comparative Examples 1 to 3. A Li foil was used for the anode active material, and a sulfide solid electrolyte (Li₂S—P₂S₅ based glass ceramic) was used for the solid electrolyte layer.

The produced battery cell was confined under confining pressure of 0.2 MPa to 1 MPa, charged to 4 V at constant current/constant voltage, and then, the resistance of the battery as a whole was measured by DC-IR measurement. The battery cell resistance of 20Ω or less was determined as ∘, and 21Ω or more was determined as x. The results are shown in Table 1. Incidentally, only the results of battery cell resistance when confined under 1 MPa are shown in Table 1.

<Adhesive Strength Evaluation>

The adhesive strength was evaluated by a peeling strength test. In the specific method of the peeling strength test, one side of an electrode was attached to the floor of equipment by an adhesive tape, a pulling terminal with an adhesive tape on its tip was adhered to another side of the electrode, and the electrode was gradually pulled. The highest stress point, immediately before the electrode was peeled off, was determined as the adhesive strength. The evaluation standards are; ∘, when the standard value was satisfied in the peeling strength test, and Δ, when the standard value was not satisfied in the peeling strength test although retained as an electrode. The results are shown in Table 1.

TABLE 1

| | | | | Contact resistance of | | | | | |
|---|---|---|---|---|---|---|---|---|---|
| | | | | modifying layer/active | | | Battery cell | | |
| | | | | material layer interface | | | resistance | | |
| | | | | (Ω) | | | (1 MPa) | | |
| | R_{A} | R_{B} | | 0.2 | 0.5 | 1 | | Evalu- | Adhesive |
| | (Ω · cm) | (Ω · cm) | R_{B}/R_{A} | MPa | MPa | MPa | Ω | ation | strength |
| Comp. Ex. 1 | 0.005 | 3127 | 6.25*10⁵ | 26.9 | 29.4 | 16.6 | 30 | x | ∘ |
| Comp. Ex. 2 | 0.005 | 260 | 5.2*10⁴ | 12.1 | 13.1 | 9.8 | 28 | x | ∘ |
| Example 1 | 0.005 | 40 | 8*10³ | 4.2 | 2.3 | 2.6 | 16 | ∘ | ∘ |
| Example 2 | 0.005 | 36 | 7.2*10³ | 3.0 | 2.4 | 1.8 | 16 | ∘ | ∘ |
| Example 3 | 0.005 | 34 | 6.8*10³ | 2.8 | 2.0 | 1.6 | 17 | ∘ | ∘ |
| Example 4 | 0.005 | 34 | 6.8*10³ | 1.9 | 1.6 | 0.5 | 15 | ∘ | ∘ |
| Example 5 | 0.005 | 22 | 4.4*10³ | 3.6 | 2.2 | 0.6 | 17 | ∘ | Δ |
| Comp. Ex. 3 | 0.01 | 2830 | 2.8*10⁵ | 28.2 | 23.4 | 17.6 | 32 | x | ∘ |
| Example 6 | 0.01 | 38 | 3.8*10³ | 3.3 | 2.7 | 1.9 | 17 | ∘ | ∘ |

As shown in Table 1, R_{B}/R_{A} in Examples 1 to 5 was 8×10³ or less, and the contact resistance between the modifying layer and the active material layer was lower compared to Comparative Examples 1 and 2. Also, R_{B}/R_{A} in Comparative Example 2 was approximately one-tenth of R_{B}/R_{A} in Comparative Example 1, as the result, the contact resistance was decreased to about a half. In contrast to this, R_{B}/R_{A} in Examples 3 and 4 was approximately one-tenth of R_{B}/R_{A} in Comparative Example 2, as the result, the contact resistance was greatly decreased to about a quarter. That is, it was confirmed that, in Examples 1 to 5, a prominent effect of greatly decreasing the contact resistance was obtained by making R_{B}/R_{A} 8×10³ or less.

Also, compared to Comparative Examples 1 and 2, the battery cell resistance when confined under 1 MPa was low in Examples 1 to 5. Incidentally, the battery cell resistance when confined under pressure of less than 1 MPa was also low in Examples 1 to 5, compared to Comparative Examples 1 and 2. As described above, it was suggested that, in order to decrease the battery cell resistance under low confining pressure condition, it is effective to decrease the contact resistance between the modifying layer and the active material layer. Incidentally, since the contact resistance between the modifying layer and the active material layer under high confining pressure condition becomes inevitably low, the contact resistance would not be a major factor in the battery cell resistance. Therefore, the effect that the decrease of the contact resistance between the modifying layer and the active material layer contributes to the decrease of the battery cell resistance is thought to be an effect exhibited more remarkably in an all solid state battery used under low confining pressure condition. Particularly, the effect may be obtained more when the all solid state battery is produced by forming the first member including the modifying layer and the second member including the active material layer as separate bodies, and joining these thereafter.

Also, in Example 6, R_{B}/R_{A} was 8×10³ or less, and the contact resistance between the modifying layer and the active material layer was lower compared to Comparative Example 3. Similarly, in Example 6, the battery cell resistance was lower compared to Comparative Example 3. As described above, it was confirmed that Example 6 showed the same tendency as Examples 1 to 5. Incidentally, it was confirmed that the adhesive strength in Example 5 was slightly low, although causing no problem in a practical use. Therefore, it was suggested that the adhesive strength tends to be lowered when the conductive auxiliary material was too much.

### Examples 7 to 9

A first member (current collector and modifying layer) was obtained in the same manner as in Example 1. The spring constant per unit area of the modifying layer was measured, and was 10 MPa/μm. The spring constant per unit area of the modifying layer was measured by the method described below. That is, a pressure of 0.5 MPa or more and 2 MPa or less was applied to the obtained first members (current collector and modifying layer), and the spring constant (MPa·μm) of the first member was calculated from the displacement, and the spring constant per unit area (MPa/μm) of the first member was calculated by dividing the obtained spring constant by the area (2025×10⁻⁶ μm²). Similarly, the spring constant per unit area (MPa/μm) of the current collector was calculated. The difference of these was determined as the spring constant per unit area of the modifying layer. Also, using the obtained cathode, the contact resistance before and after a durability test was measured by varying the confining pressure. Incidentally, as the durability test, a test wherein a specimen is stored for two months at 80° C.

### Examples 10 to 20

A cathode was obtained in the same manner as in Example 7 except that the spring constant per unit area and the thickness of the modifying layer was changed to the values shown in Table 2, while maintaining R_{B}/R_{A}=8×10³ (R_{A}=0.005 Ω·cm, R_{B}=40 Ω·cm). The spring constant per unit area and the thickness of the modifying layer were varied by adjusting the coating weight and the surface roughness (Ra). Incidentally, in Example 12, after forming the modifying layer on the current collector, the modifying layer was densified by pressing.

TABLE 2

| | | | | | Contact resistance of | |
|---|---|---|---|---|---|---|
| | | | | | modifying layer/active | |
| | | | | | material layer interface | |
| | | Modifying layer | | | (Ω) | |
| | | Spring | | Confining | | After |
| | | constant | Thickness | pressure | | durability |
| | R_{B}/R_{A} | (MPa/μm) | (μm) | (MPa) | Initial | test |
| Example 7 | 8*10³ | 10 | 2 | 0.2 | 4.2 | 4.3 |
| Example 8 | | 10 | 2 | 3 | 2.6 | 2.7 |
| Example 9 | | 10 | 2 | 10 | 1.6 | 1.3 |
| Example 10 | | 7 | 0.7 | 0.2 | 1.4 | 1.5 |
| Example 11 | | 7 | 0.7 | 3 | 1.2 | 1.3 |
| Example 12 | | 7 | 2 | 0.2 | 1.4 | 1.5 |
| Example 13 | | 4 | 3 | 0.1 | 4.1 | 4.5 |
| Example 14 | | 4 | 3 | 0.2 | 1.2 | 1.3 |
| Example 15 | | 4 | 3 | 3 | 1.1 | 1.2 |
| Example 16 | | 1 | 8 | 0.2 | 1.5 | 1.3 |
| Example 17 | | 1 | 8 | 3 | 1.4 | 1.3 |
| Example 18 | | 0.5 | 20 | 0.2 | 1.2 | 4.4 |
| Example 19 | | 0.5 | 20 | 3 | 1.1 | 4.8 |
| Example 20 | | 0.5 | 20 | 10 | 1.2 | 1.5 |

As shown in Table 2, in each of Examples 7 to 20, it was confirmed that the contact resistance before the durability test (initial) was low. Particularly, in Examples 10 to 12, 14 to 17, it was confirmed that the contact resistance before the durability test (initial) could be lowered greatly, and further, the contact resistance after the durability test could be maintained low. That is, it was confirmed that the spring constant per unit area of the modifying layer of 1 MPa/μm or more and 7 MPa/μm or less and the confining pressure of 0.2 MPa or more and 3 MPa or less were particularly preferable.

### REFERENCE SIGNS LIST

1 . . . current collector
2 . . . modifying layer
3 . . . active material layer
4 . . . base material
10 . . . electrode

What is claimed is:

1. An electrode used for an all solid state battery, and
the electrode comprises a current collector, a modifying layer including a polymer and a conductive auxiliary material, and an active material layer, in this order, and
when a volume resistivity value of the modifying layer is regarded as RA, and a volume resistivity value of the active material layer is regarded as R_{B}, R_{B}/R_{A} is 8×10³ or less, and the R_{B} is 40 Ω·cm or less.

2. The electrode according to claim 1, wherein the R_{A} is 0.01 Ω·cm or less.

3. The electrode according to claim 1, wherein the R_{A} is 0.005 Ω·cm or more.

4. The electrode according to claim 1, wherein the R_{B} is 22 Ω·cm or more.

5. The electrode according to claim 1, wherein the R_{B}/R_{A} is 3.8×10³ or more

6. The electrode according to claim 1, wherein a spring constant per unit area of the modifying layer is 1 MPa/μm or more and 7 MPa/μm or less.

7. An all solid state battery comprising: a cathode, a solid electrolyte layer, and an anode, in this order, and
at least one of the cathode and the anode is the electrode according to claim 1.

8. The all solid state battery according to claim 7, wherein the all solid state battery further comprises a confining member that applies a confining pressure in the thickness direction of the cathode, the solid electrolyte layer and the anode, and
the confining pressure is 0.05 MPa or more and 3 MPa or less.

9. The all solid state battery according to claim 8, wherein a spring constant per unit area of the modifying layer is 1 MPa/μm or more and 7 MPa/μm or less, and
the confining pressure is 0.2 MPa or more and 3 MPa or less.

10. The all solid state battery according to claim 7, wherein the cathode is the electrode.

11. A method for producing the electrode according to claim 1, the method characterized by comprising steps of:
a first preparing step of preparing a first member including the current collector and the modifying layer formed on one side of the current collector,
a second preparing step of preparing a second member including a base material and the active material layer formed on one side of the base material, and
a joining step of joining the modifying layer in the first member and the active material layer in the second member, facing to each other.
